(19) United States
(12) Patent Application Publication
(10) Pub. No.: US 2024/0335906 A1
(43) Pub. Date: Oct. 10, 2024

(54) LASER BLANKING DEVICE

(71) Applicant: KOMATSU INDUSTRIES CORPORATION, Kanazawa-shi, Ishikawa (JP)

(72) Inventors: Yuto ECHIGO, Ishikawa (JP); Hikaru NISHIKAWA, Ishikawa (JP)

(21) Appl. No.: 18/700,020

(22) PCT Filed: Nov. 16, 2022
(86) PCT No.: PCT/JP2022/042556

§ 371 Date: Apr. 10, 2024

(30) Foreign Application Priority Data
Jan. 31, 2022 (JP) 2022-013267

(51) Int. Cl. B23K 26/08; B23K 26/38

(52) U.S. Cl. CPC B23K 26/0838; B23K 26/0876; B23K 26/38

(57) ABSTRACT

A laser blanking device includes an upstream laser head, a downstream laser head, and an inter-head conveyor. The upstream laser head emits a laser. The downstream laser head is disposed downstream of the upstream laser head in a conveyance direction of a workpiece, and emits a laser. The inter-head conveyor includes a loading section on which a workpiece is loaded between the upstream laser head and the downstream laser head, and conveys the workpiece loaded thereon. An end on the upstream side of the loading section is movable along the conveyance direction together with the upstream laser head. An end on the downstream side of the loading section is movable along the conveyance direction together with the downstream laser head.

### CROSS-REFERENCE TO RELATED APPLICATIONS

This application is a U.S. National stage application of International Application No. PCT/JP2022/042556, filed on Nov. 16, 2022. This U.S. National stage application claims priority under 35 U.S.C. § 119 (a) to Japanese Patent Application No. 2022-013267, filed in Japan on Jan. 31, 2022, the entire contents of which are hereby incorporated herein by reference.

The present invention relates to a laser blanking device.

### BACKGROUND

In recent years, in a press line, a laser blanking device for blanking with a laser cutting machine has been used, instead of blanking with a press machine, (for example, see Japanese Patent No. 4705139).

Japanese Patent No. 4705139 discloses a laser blanking device that includes a laser head, a conveyor belt disposed below the laser head to collect scraps, and a belt placed below the laser head with a gap therebetween and surrounding the conveyor belt to convey workpieces.

### SUMMARY

Laser blanking devices generally have lower productivity than press machines, and it has been proposed to install two laser heads in them, for example, to speed up the process.

However, as Japanese Patent No. 4705139 describes, for example, a laser blanking device includes a mechanism attached to the laser head, which makes it difficult for two laser heads to come closer each other. As a result, it has been difficult to improve productivity depending on the cutting shape of a workpiece.

The present disclosure is directed to provide a laser blanking device the productivity of which can be improved.

A laser blanking device according to an aspect of the present disclosure includes a first laser head, a second laser head, and an inter-head conveyor. The first laser head is configured to emit a laser. The second laser head is disposed downstream of the first laser head in a conveyance direction of a workpiece and configured to emit a laser beam. The inter-head conveyor includes a first loading section arranged between the first laser head and the second laser head for loading a workpiece, and is configured to convey the workpiece

loaded thereon. A first end on an upstream side of the first loading section is movable along the conveyance direction together with the first laser head. A second end on a downstream side of the first loading section is movable along the conveyance direction together with the second laser head.

According to an aspect of the present disclosure, it is possible to provide a laser blanking device the productivity of which can be improved.

### BRIEF DESCRIPTION OF THE DRAWINGS

FIG. 1 is a schematic diagram showing a laser blanking line using a laser blanking device according to an embodiment of the present disclosure.

FIG. 2 is a perspective view showing a laser blanking device according to an embodiment of the present disclosure.

FIG. 3 is a side view showing a laser blanking device according to an embodiment of the present disclosure.

FIG. 4 is a perspective view showing a conveyor in a laser blanking device according to an embodiment of the present disclosure.

FIG. 5 is a perspective view showing a take-up mechanism in a laser blanking device according to an embodiment of the present disclosure.

FIG. 6 is a perspective view showing a configuration of an upstream support frame, a plurality of pulleys, an upstream laser head, and an upstream dust collecting container in a laser blanking device according to an embodiment of the present disclosure.

FIG. 7 is an enlarged perspective view showing the laser head shown in FIG. 6 and therearound.

FIG. 8 is a side view showing a state in which an upstream laser head and a downstream laser head of a laser blanking device according to an embodiment of the present disclosure have moved.

FIG. 9 is a side view showing a state in which an upstream laser head and a downstream laser head of a laser blanking device according to an embodiment of the present disclosure have moved.

FIG. 10A is a diagram showing an example of the shape of a coil material after cut, and FIG. 10B is a diagram showing the movement paths of an upstream laser head and a downstream laser head when cutting a member shown in FIG. 10A from the coil material while the coil material is stopped.

FIG. 11A is a diagram showing the movement path of each laser head when the moving ranges of the upstream laser head and the downstream laser head do not overlap, and FIG. 11B is a diagram showing the movement path of each laser head when the moving ranges of the upstream laser head and the downstream laser head overlap.

FIGS. 12A and 12B are each a side view showing a laser blanking device of an embodiment according to a modification of the present disclosure.

### DETAILED DESCRIPTION

A laser blanking device according to the present disclosure will be described below with reference to the drawings.

### (Overview of Laser Blanking Line 1)

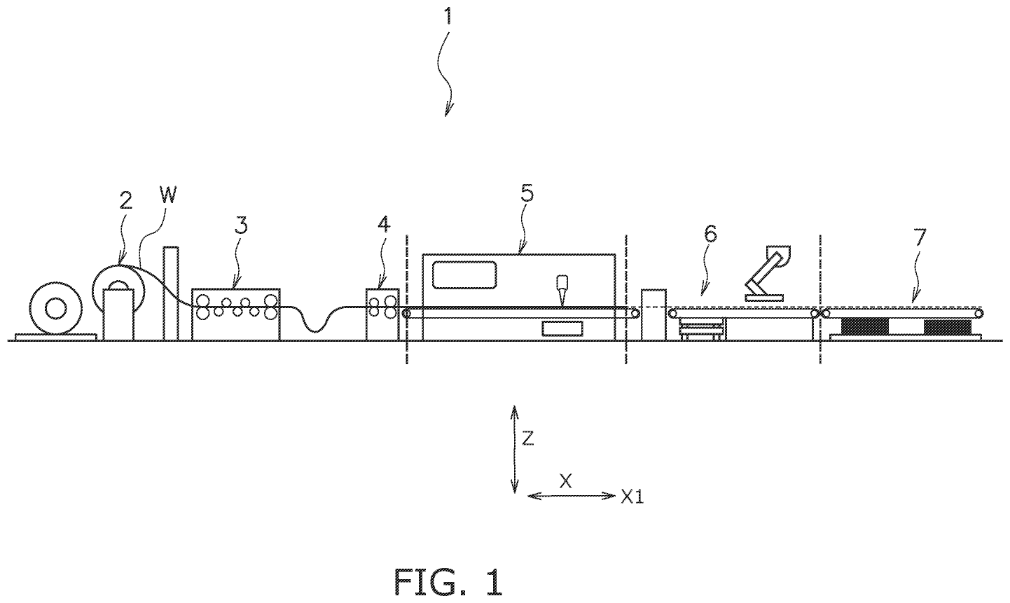

FIG. 1 is a schematic diagram showing a laser blanking line 1 using a laser blanking device of the present embodiment.

The laser blanking line 1 is configured to cut a coil material W into a desired shape. The laser blanking line 1 includes an uncoiler 2, a leveler 3, a feeder 4, a laser blanking device 5, a cleaning device 6, and a piler 7.

The uncoiler 2 rotates to unwind a coil material. The leveler 3 has a plurality of rollers, and corrects the curl of a coil material W by feeding out the coil material W through the rollers. The feeder 4 has, for example, a pair of rollers, for conveying the coil material W to the laser blanking device 5 by rotating the rollers. The laser blanking device 5 cuts a coil material into members of a desired shape. The cleaning device 6 cleans the members of the desired shape. The piler 7 stacks the members of the desired shape using a suction device or the like.

### (Laser Blanking Device 5)

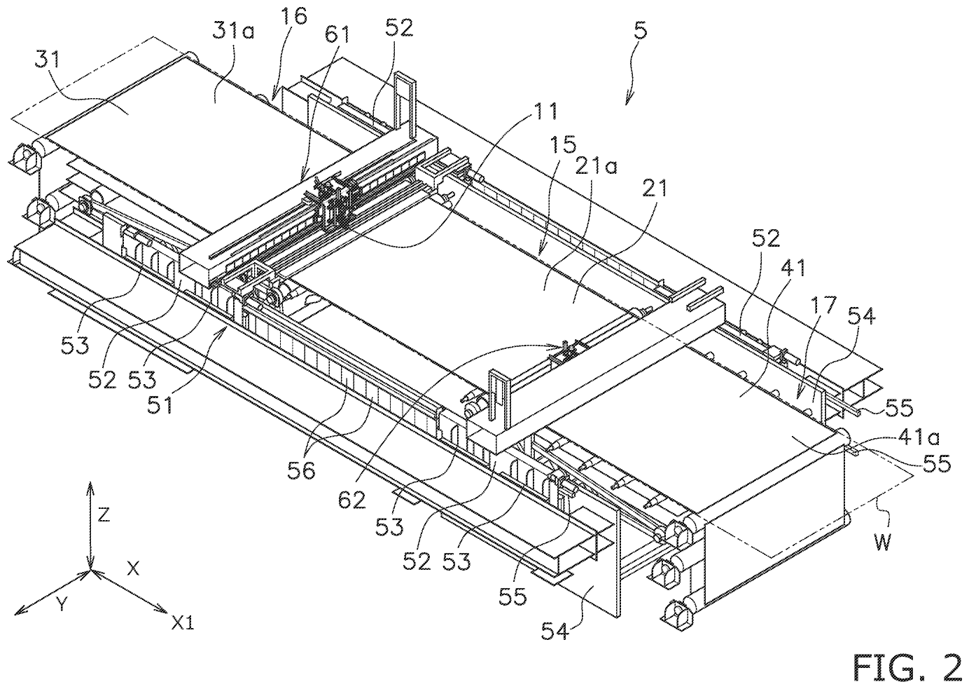

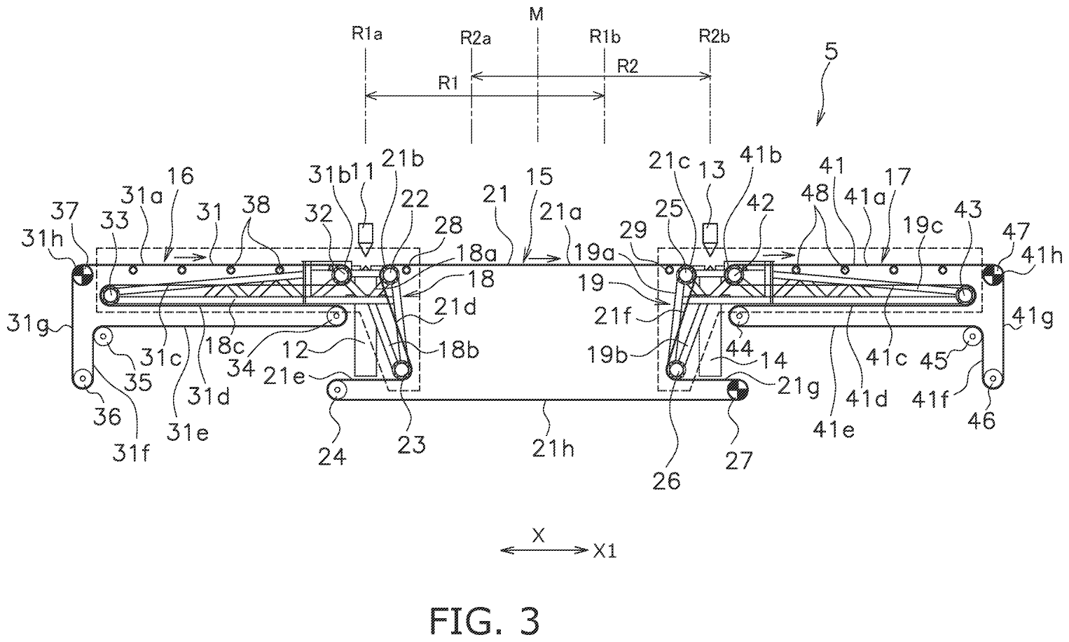

FIG. 2 is a perspective view showing the laser blanking device 5 of the present embodiment. FIG. 3 is a schematic front view of the laser blanking device 5. A conveyance direction X1 of a coil material W is shown, and the direction including the upstream side and downstream side of the conveyance direction X1 is shown as a first direction X. The perpendicular and parallel direction to the first direction X is shown as a second direction Y. The up-down direction perpendicular to the first direction X and the second direction Y is shown as a third direction Z.

As shown in FIGS. 2 and 3, the laser blanking device 5 includes an upstream laser head 11, an upstream dust collecting container 12, a downstream laser head 13, a downstream dust collecting container 14, an inter-head conveyor 15, an upstream conveyor 16, a downstream conveyor 17, an upstream support frame 18, and a downstream support frame 19.

As shown in FIGS. 2 to 4, the upstream laser head 11 emits a laser downward to cut a workpiece W when conveyed. The upstream dust collecting container 12 collects dust, such as powder, fume, or scraps, generated by laser cutting by the upstream laser head 11. The upstream dust collecting container 12 is movable along the first direction X together with the upstream laser head 11. The downstream laser head 13 is disposed downstream of the upstream laser head 11. The downstream dust collecting container 14 is arranged below the downstream laser head 13. The downstream dust collecting container 14 is movable along the first direction X together with the downstream laser head 13. The downstream dust collecting container 14 collects dust, such as powder, fume, or scraps, generated by laser cutting by the downstream laser head 13.

The inter-head conveyor 15 conveys a workpiece from the upstream laser head 11 to the downstream laser head 13. The inter-head conveyor 15 includes a loading section 21a on which a workpiece is loaded and conveyed. The loading section 21a is disposed between the upstream laser head 11 and the downstream laser head 13.

The upstream conveyor 16 is arranged upstream of the upstream laser head 11. The upstream conveyor 16 conveys a workpiece toward the upstream laser head 11. The upstream conveyor 16 includes a loading section 31a on which a workpiece is loaded and conveyed. The upstream conveyor 16 is separated from the inter-head conveyor 15 by a predetermined distance for a laser passage opening. The upstream laser head 11 is arranged above the laser passage opening, and the upstream dust collecting container 12 is arranged below the laser passage opening.

The downstream conveyor 17 is arranged downstream of the downstream laser head 13. The downstream conveyor 17 conveys a workpiece W, which has been cut by the downstream laser head 13, to the cleaning device 6. The downstream conveyor 17 includes a loading section 41a on which a workpiece is loaded and conveyed. The downstream conveyor 17 is separated from the inter-head conveyor 15 by a predetermined distance for a laser passage opening. The downstream laser head 13 is arranged above the laser passage opening, and the downstream dust collecting container 14 is arranged below the laser passage opening.

The upstream support frame 18 supports the upstream laser head 11, the upstream dust collecting container 12, and a plurality of movable pulleys which will be described later. The upstream support frame 18 is movable along the first direction X.

The downstream support frame 19 supports the downstream laser head 13, the downstream dust collecting container 14, and a plurality of movable pulleys which will be described later. The downstream support frame 19 is movable in the first direction X.

### (Inter-Head Conveyor 15)

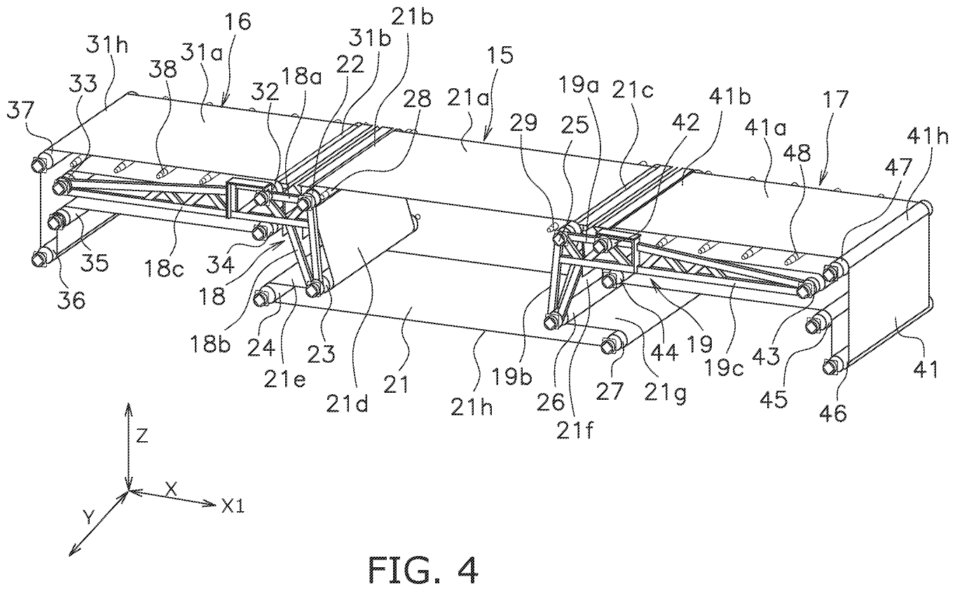

FIG. 4 is a perspective view showing the inter-head conveyor 15, the upstream conveyor 16, and the downstream conveyor 17. As shown in FIGS. 3 and 4, the inter-head conveyor 15 includes a belt 21, an upstream movable pulley 22, an upstream guide pulley 23, an upstream fixed pulley 24, a downstream movable pulley 25, a downstream guide pulley 26, a downstream fixed pulley 27, an upstream support roller 28, and a downstream support roller 29.

The belt 21 has an endless shape. For example, the belt 21 may be a timing belt. The belt 21 includes the loading section 21a on which a workpiece is loaded and conveyed. The loading section 21a is arranged horizontally. The belt 21 is wound around the upstream movable pulley 22, the upstream guide pulley 23, the upstream fixed pulley 24, the downstream fixed pulley 27, the downstream guide pulley 26, and the downstream movable pulley 25. When the belt 21 rotates in a predetermined direction, a workpiece W loaded on the placing portion 21a is conveyed. Hereinafter, the guiding direction of the belt by each of the pulleys will be described based on the direction of rotation of the belt 21 to convey a workpiece.

The upstream movable pulley 22 is disposed inside the endless belt 21. The upstream movable pulley 22 is arranged at the upstream end 21b of the loading section 21a of the belt 21. The upstream movable pulley 22 guides the belt 21 from the upstream guide pulley 23 toward the downstream movable pulley 25. The upstream movable pulley 22 guides the belt 21 downstream in the first direction X from diagonally upward at the end portion 21b. The upstream movable pulley 22 is movable along the first direction X together with the upstream laser head 11. FIG. 3 shows a state in which the upstream movable pulley 22, the upstream guide pulley 23, and the upstream laser head 11 has moved to the upstreammost position. The upstream movable pulley 22 is rotatably supported by the upstream support frame 18, the details of which will be described later.

The upstream guide pulley 23 is disposed outside the endless belt 21. The upstream guide pulley 23 is arranged below the upstream movable pulley 22 in the height direction. The upstream guide pulley 23 is arranged slightly downstream from vertically below the upstream movable pulley 22. With the configuration, the portion 21d of the belt 21 between the upstream guide pulley 23 and the upstream movable pulley 22 is, as it goes upward, inclined toward upstream. The upstream guide pulley 23 guides the belt 21 from the upstream fixed pulley 24 toward the upstream movable pulley 22. The upstream guide pulley 23 guides the belt 21 obliquely upward from downstream of conveyance direction X1. The upstream guide pulley 23 is movable along the first direction X together with the upstream laser head 11 and the upstream movable pulley 22. The upstream guide pulley 23, the upstream laser head 11, and the upstream movable pulley 22 are movable along the first direction X with their positional relationship being maintained. The upstream guide pulley 23 is rotatably supported by the upstream support frame 18, the details of which will be described later.

The upstream fixed pulley 24 is disposed inside the endless belt 21. The upstream fixed pulley 24 is arranged below the upstream movable pulley 22 in the height direction. The upstream fixed pulley 24 is arranged below the upstream guide pulley 23 in the height direction. The upstream fixed pulley 24 is arranged upstream of the upstream movable pulley 22 and the upstream guide pulley 23 in the first direction X. The upstream fixed pulley 24 is mounted at a fixed position. The upstream fixed pulley 24 does not move along the first direction X except for movement to prevent deflection of the belt 21 with a take-up mechanism 71, which will be described later. In this specification, the “fixed pulley is mounted at a fixed position” encompasses a configuration in which the position to be mounted is completely fixed by a bolt and the like as well as a configuration in which the position to be mounted is shifted to prevent the belt from deflecting with the take-up mechanism. The upstream fixed pulley 24 guides the belt 21 from the downstream fixed pulley 27 toward the upstream guide pulley 23. The upstream fixed pulley 24 guides the belt 21 from upstream to downstream in the first direction X. The portion 21e of the belt 21 between the upstream fixed pulley 24 and the upstream guide pulley 23 is arranged parallel to the loading section 21a.

The downstream movable pulley 25 is disposed inside the endless belt 21. The downstream movable pulley 25 is disposed downstream of the upstream movable pulley 22 in the first direction X. The downstream movable pulley 25 is arranged at the downstream end 21c of the loading section 21a of the belt 21. The position of the downstream movable pulley 25 in the height direction is the same as the position of the upstream movable pulley 22. The downstream movable pulley 25 guides the belt 21 from the upstream movable pulley 22 to the downstream guide pulley 26. The downstream movable pulley 25 guides the belt 21, at the end 21c, from downstream in the first direction X toward obliquely downward. The downstream movable pulley 25 is movable along the first direction X together with the downstream laser head 13. FIG. 3 shows a state in which the downstream movable pulley 25, the downstream guide pulley 26, and the downstream laser head 13 have moved to the downstreammost. The downstream movable pulley 25 is rotatably supported by the downstream support frame 19, the details of which will be described later.

The downstream guide pulley 26 is disposed outside the endless belt 21. The downstream guide pulley 26 is arranged at the same position as the upstream guide pulley 23 in the height direction. The downstream guide pulley 26 is arranged below the downstream movable pulley 25 in the height direction. The downstream guide pulley 26 is arranged slightly upstream from vertically below the downstream movable pulley 25. With the configuration, the portion 21f of the belt 21 from the downstream movable pulley 25 to the downstream guide pulley 26 is, as it goes downward, inclined toward upstream. The downstream guide pulley 26 guides the belt 21 from the downstream movable pulley 25 toward the downstream fixed pulley 27. The downstream guide pulley 26 guides the belt 21 toward downstream in the first direction X from diagonally downward. The downstream guide pulley 26 is movable along the first direction X together with the downstream laser head 13 and the downstream movable pulley 25. The downstream guide pulley 26, the downstream laser head 13, and the downstream movable pulley 25 are movable along the first direction X while their positional relationship is maintained. The downstream guide pulley 26 is rotatably supported by the downstream support frame 19, which will be described later.

The downstream fixed pulley 27 is disposed inside the endless belt 21. The downstream fixed pulley 27 is arranged at the same position as the upstream fixed pulley 24 in the height direction. The downstream fixed pulley 27 is arranged below the downstream movable pulley 25 in the height direction. The downstream fixed pulley 27 is arranged below the downstream guide pulley 26 in the height direction. The downstream fixed pulley 27 is arranged downstream of the downstream movable pulley 25 and the downstream guide pulley 26 in the first direction X. The downstream fixed pulley 27 is mounted at a fixed position. The downstream fixed pulley 27 does not move along the first direction X. The downstream fixed pulley 27 guides the belt 21 from the downstream guide pulley 26 toward the upstream fixed pulley 24. The downstream fixed pulley 27 guides the belt 21 from downstream to upstream in the first direction X. The portion 21g of the belt 21 between the downstream guide pulley 26 and the downstream fixed pulley 27 is arranged parallel to the loading section 21a.

Note that the portion 21h of the belt 21 between the downstream fixed pulley 27 and the upstream fixed pulley 24 is also arranged parallel to the loading section 21a.

The upstream support roller 28 is arranged downstream of the upstream movable pulley 22. The upstream support roller 28 is disposed below the loading section 21a of the belt 21, and supports the loading section 21a from below. The upstream support roller 28 is configured to decrease deflection of the belt 21. The upstream support roller 28 moves along the first direction X together with the upstream movable pulley 22. The upstream support roller 28 is rotatably supported by the upstream support frame 18, which will be described later.

The downstream support roller 29 is arranged upstream of the downstream movable pulley 25. The downstream support roller 29 is arranged below the loading section 21a of the belt 21, and supports the loading section 21a from below. The downstream support roller 29 is configured to decrease deflection of the belt 21. The downstream support roller 29 moves along the first direction X together with the downstream movable pulley 25. The downstream support roller 29 is rotatably supported by the downstream support frame 19, which will be described later.

The downstream fixed pulley 27 is connected to a drive source such as a motor, and is rotated by the driving force of the drive source. The upstream movable pulley 22, the upstream guide pulley 23, the upstream fixed pulley 24, the downstream movable pulley 25, the downstream guide pulley 26, the upstream support roller 28, and the downstream support roller 29 are driven by the rotation of the belt 21 following the rotation of the downstream fixed pulley 27.

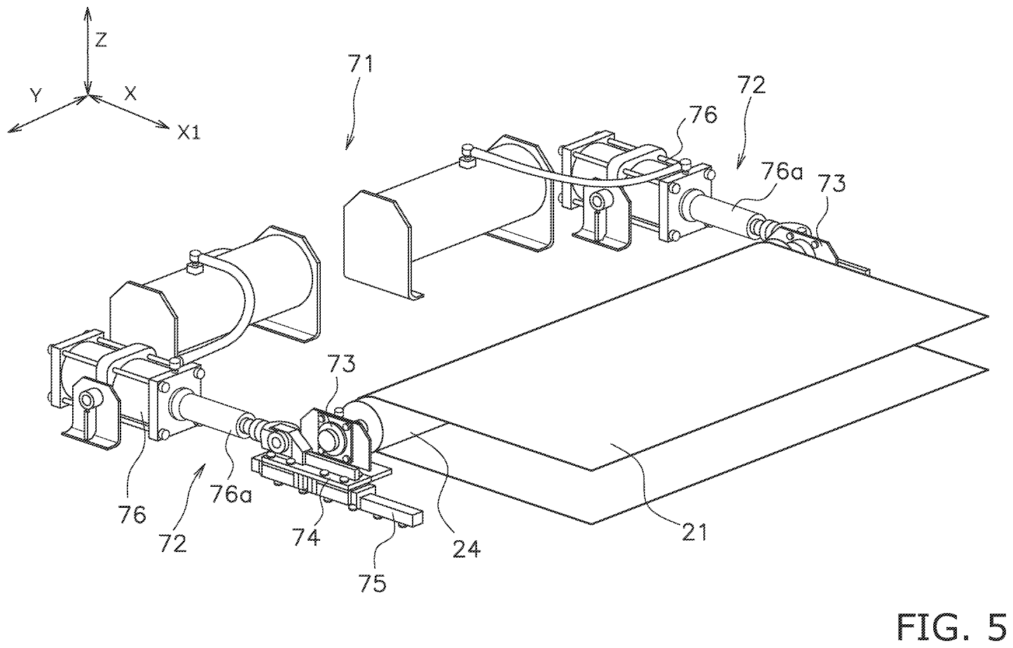

The take-up mechanism 71 (not shown in FIGS. 2 to 4) is disposed on the inter-head conveyor 15 to prevent the belt 21 from deflecting. FIG. 5 is a perspective view showing the take-up mechanism 71. The take-up mechanism 71 includes a pair of left and right cylinder mechanisms 72. The left and right pair of cylinder mechanisms 72 each includes a shaft support portion 73, a slide carrier 74 (only one shown), a slide rail 75 (only one shown), and an air cylinder 76. The shaft support portions 73 of the pair of cylinder mechanisms 72 rotatably support the shaft of the upstream fixed pulley 24 at both ends in the second direction Y. The slide carrier 74 has the shaft support portion 73 fixed thereto. A groove is formed in the lower surface of the slide carrier 74 along the first direction. The slide rail 75 is arranged along the first direction X. The slide rail 75 fits in the groove in the slide carrier 74. As such, the slide carrier 74 is configured to be movable along the slide rail 75. The air cylinder 76 is arranged upstream of the slide carrier 74 in the first direction X. A tip of the rod 76a of the air cylinder 76 is rotatably connected to the slide carrier 74. When the air cylinder 76 pulls in the rod 76a, the slide carrier 74 is pulled upstream in the first direction X, and the upstream fixed pulley 24 is also pulled upstream along with the shaft support 73 fixed to the slide carrier 74. Accordingly, tension can be applied to the belt 21, and the belt 21 can be prevented from being deflected.

### (Upstream Conveyor 16)

As shown in FIGS. 3 and 4, the upstream conveyor 16 includes a belt 31, a movable pulley 32, a movable guide pulley 33, a fixed pulley 34, a fixed guide pulley 35, a fixed pulley 36, a fixed pulley 37. and a plurality of support rollers 38.

The belt 31 has an endless shape. For example, the belt 31 may be a timing belt. The belt 31 includes a loading section 31a on which a workpiece is loaded and conveyed. The loading section 31a is disposed horizontally. The belt 31 is wound around the movable pulley 32, the movable guide pulley 33, the fixed pulley 34, the fixed guide pulley 35, the fixed pulley 36, and the fixed pulley 37.

The movable pulley 32 is disposed inside the endless belt 31. The movable pulley 32 is arranged at the downstream end 31b of the loading section 31a of the belt 31. The movable pulley 32 is arranged upstream of the upstream movable pulley 22. The movable pulley 32 of the upstream conveyor 16 and the upstream movable pulley 22 of the above-mentioned inter-head conveyor 15 are separated from each other by a predetermined distance for a laser passage opening. The upstream laser head 11A emits a laser toward the laser passage opening. The movable pulley 32 guides the belt 31 from fixed pulley 37 toward movable guide pulley 33. The movable pulley 32 guides the belt 31 from downstream to upstream in the first direction X. The movable pulley 32 is movable along the first direction X together with the upstream laser head 11. FIG. 3 shows a state in which the movable pulley 32 has moved to the upstreammost. The movable pulley 32 is rotatably supported by the upstream support frame 18, which will be described later.

The movable guide pulley 33 is disposed outside the endless belt 31. The movable guide pulley 33 is arranged below the movable pulley 32 in the height direction. The movable guide pulley 33 is arranged upstream of the movable pulley 32 in the first direction X. The movable guide pulley 33 guides the belt 31 from the movable pulley 32 toward the fixed pulley 34. The movable guide pulley 33 guides the belt 31 in the first direction X from upstream to downstream. The portion 31c of the belt 31 between the movable pulley 32 and the movable guide pulley 33 is arranged parallel to the loading section 31a.

The fixed pulley 34 is disposed inside the endless belt 31. The fixed pulley 34 is mounted at a fixed position. The fixed pulley 34 does not move along the first direction X except for movement to prevent deflection of the belt 21 with a take-up mechanism. Note that the details of the structure are omitted herein, but the take-up mechanism may have basically the same structure as the structure described using FIG. 5. The fixed pulley 34 is arranged below the movable guide pulley 33 in the height direction. The fixed pulley 34 is arranged to be located approximately vertically below the movable pulley 32 when the movable pulley 32 is moved to the upstreammost. The fixed pulley 34 guides the belt 31 from movable guide pulley 33 toward fixed guide pulley 35. The fixed pulley 34 guides the belt 31 from downstream to upstream in the first direction X. The portion 31d of the belt 31 from the movable guide pulley 33 to the fixed pulley 34 is arranged parallel to the loading section 31a.

The fixed guide pulley 35 is disposed outside the endless belt 31. The fixed guide pulley 35 is arranged below the fixed pulley 34 in the height direction. The fixed guide pulley 35 is arranged upstream of the fixed pulley 34 in the first direction X. The fixed guide pulley 35 is arranged to be located approximately vertically below the movable guide pulley 33 in a state where the movable guide pulley 33 has moved to the upstreammost. The fixed guide pulley 35 is mounted at a fixed position. The fixed guide pulley 35 guides the belt 31 from the fixed pulley 34 to the fixed pulley 36. The fixed guide pulley 35 guides the belt 31 from upstream to downward in the conveyance direction X1. The portion 31e of the belt 31 from the fixed pulley 34 to the fixed guide pulley 35 is arranged parallel to the loading section 31a.

The fixed pulley 36 is disposed inside the endless belt 31. The fixed pulley 36 is arranged below the fixed guide pulley 35 in the height direction. The fixed pulley 36 is arranged upstream of the fixed guide pulley 35 in the first direction X. The fixed pulley 36 is mounted at a fixed position. The fixed pulley 36 is fixedly set in a machine room where the laser blanking device 5 is installed. The fixed pulley 36 guides the belt 31 from the fixed guide pulley 35 to the fixed pulley 37. The fixed pulley 36 guides the belt 31 from downward to upward. The portion 31f of the belt 31 from the fixed guide pulley 35 to the fixed pulley 36 is arranged along the vertical direction.

The fixed pulley 37 is disposed inside the endless belt 31. The fixed pulley 37 is arranged at the upstream end 31h of the loading section 31a. The fixed pulley 37 is arranged downstream of the movable pulley 32. The position of the fixed pulley 37 in the height direction is the same as that of the movable pulley 32. The fixed pulley 37 is arranged vertically above the fixed pulley 36. The fixed pulley 37 is mounted at a fixed position. The fixed pulley 37 is fixedly set in the machine room where the laser blanking device 5 is installed. The fixed pulley 37 guides the belt 31 from the fixed pulley 36 to the movable pulley 32. The fixed pulley 37 guides the belt 31 from upward to downstream in the conveyance direction X1. The portion 31g of the belt 31 between the fixed pulley 36 and the fixed pulley 37 is arranged along the vertical direction.

The plurality of support rollers 38 is arranged between the fixed pulley 37 and the movable pulley 32. The plurality of support rollers 38 is arranged below the loading section 31a of the belt 31, and supports the loading section 31a from below. The plurality of support rollers 38 is configured to decrease deflection of the belt 31.

The fixed pulley 37 is connected to a drive source such as a motor, and is rotated by the driving force of the drive source. The movable pulley 32, the movable guide pulley 33, the fixed pulley 34, the fixed guide pulley 35, the fixed pulley 36, and the plurality of support rollers 38 are driven by the rotation of the belt 31 following the rotation of the fixed pulley 37.

### (Downstream Conveyor 17)

As shown in FIGS. 3 and 4, the downstream conveyor 17 includes a belt 41, a movable pulley 42, a movable guide pulley 43, a fixed pulley 44, a fixed guide pulley 45, a fixed pulley 46, a fixed pulley 47. and a plurality of support rollers 48.

The belt 41 has an endless shape. For example, the belt 41 may be a timing belt. The belt 41 includes a loading section 41a on which a workpiece is loaded and conveyed. The loading section 41a is arranged horizontally. The belt 41 is wound around the movable pulley 42, the movable guide pulley 43, the fixed pulley 44, the fixed guide pulley 45, the fixed pulley 46, and the fixed pulley 47.

The movable pulley 42 is disposed inside the endless belt 41. The movable pulley 42 is arranged at the upstream end 41b of the loading section 41a of the belt 41. The movable pulley 42 is arranged downstream of the downstream movable pulley 25. The movable pulley 42 of the downstream conveyor 17 and the downstream movable pulley 25 of the above-mentioned inter-head conveyor 15 are separated from each other by a predetermined distance for a laser passage opening. The downstream laser head 13 emits a laser toward the laser passage opening. The movable pulley 42 guides belt 41 from movable guide pulley 43 toward fixed pulley 47. The movable pulley 42 guides the belt 41 from upstream to downstream in the conveyance direction X1. The movable pulley 42 is movable along the first direction X together with the downstream laser head 13. FIG. 3 shows a state in which the movable pulley 42 has moved to the downstreammost. The movable pulley 42 is rotatably supported by the downstream support frame 19, which will be described later.

The movable guide pulley 43 is disposed outside the endless belt 41. The movable guide pulley 43 is arranged below the movable pulley 42 in the height direction. The movable guide pulley 43 is arranged downstream of the movable pulley 42 in the first direction X. The movable guide pulley 43 guides the belt 41 from the fixed pulley 44 toward the movable pulley 42. The movable guide pulley 43 guides the belt 41 from downstream to upstream in the first direction X. The portion 41c of the belt 41 between the movable pulley 42 and the movable guide pulley 43 is arranged parallel to the loading section 41a.

The fixed pulley 44 is disposed inside the endless belt 41. The fixed pulley 44 is mounted at a fixed position. The fixed pulley 44 does not move along the first direction X except for movement to prevent deflection of the belt 21 with a take-up mechanism. Note that the details of the structure are omitted, but the take-up mechanism may have basically the same structure as the structure described using FIG. 5. The fixed pulley 44 is arranged below the movable guide pulley 43 in the height direction. The fixed pulley 44 is arranged to be located approximately vertically below the movable pulley 42 in a state where the movable pulley 42 has moved to the upstreammost. The fixed pulley 44 guides belt 41 from the fixed guide pulley 45 toward the movable guide pulley 43. The fixed pulley 44 guides the belt 41 in the first direction X from upstream to downstream. The portion 41d of the belt 41 from the movable guide pulley 43 to the fixed pulley 44 is arranged parallel to the loading section 41a.

The fixed guide pulley 45 is disposed outside the endless belt 41. The fixed guide pulley 45 is arranged below the fixed pulley 44 in the height direction. The fixed guide pulley 45 is arranged downstream of the fixed pulley 44 in the first direction X. The fixed guide pulley 45 is arranged to be located approximately vertically below the movable guide pulley 43 in a state where the movable guide pulley 43 has moved to the upstreammost. The fixed guide pulley 45 is mounted at a fixed position. The fixed guide pulley 45 guides the belt 41 from the fixed pulley 46 toward the fixed pulley 44. The fixed guide pulley 45 guides the belt 31 from upward to upstream in the conveyance direction X1. The portion 41e of the belt 41 from the fixed pulley 44 to the fixed guide pulley 45 is arranged parallel to the loading section 41a.

The fixed pulley 46 is disposed inside the endless belt 41. The fixed pulley 46 is arranged below the fixed guide pulley 45 in the height direction. The fixed pulley 46 is arranged downstream of the fixed guide pulley 45 in the first direction X. The fixed pulley 46 is mounted at a fixed position. The fixed pulley 46 is fixedly set in the machine room where the laser blanking device 5 is installed. The fixed pulley 46 guides the belt 41 from the fixed pulley 47 toward the fixed guide pulley 45. The fixed pulley 46 guides the belt 41 from downward to upward. The portion 41f of the belt 41 from the fixed pulley 46 to the fixed guide pulley 45 is arranged along the vertical direction.

The fixed pulley 47 is disposed inside the endless belt 41. The fixed pulley 47 is arranged at the downstream end 41h of the loading section 41a. The fixed pulley 47 is arranged downstream of the movable pulley 42. The position of the fixed pulley 47 in the height direction is the same as that of the movable pulley 42. The fixed pulley 47 is arranged vertically above the fixed pulley 46. The fixed pulley 47 is mounted at a fixed position. The fixed pulley 47 is fixedly set in the machine room where the laser blanking device 5 is installed. The fixed pulley 47 guides belt 41 from movable pulley 42 to fixed pulley 46. The fixed pulley 47 guides the belt 41 from downstream in the first direction X toward downward. The portion 41g of the belt 41 between the fixed pulley 46 and the fixed pulley 47 is arranged along the vertical direction.

The plurality of support rollers 48 is arranged between the fixed pulley 47 and the movable pulley 42. The plurality of support rollers 48 is arranged below the loading section 41a of the belt 41, and supports the loading section 41a from below. The plurality of support rollers 48 is configured to decrease deflection of the belt 41.

The loading section 21a of the inter-head conveyor 15, the loading section 31a of the upstream conveyor 16, and the loading section 41a of the downstream conveyor 17 are arranged horizontally.

The fixed pulley 47 is connected to a drive source, such as a motor, and is rotated by the driving force of the drive source. The movable pulley 42, the movable guide pulley 43, the fixed pulley 44, the fixed guide pulley 45, the fixed pulley 46, and the plurality of support rollers 48 are driven by the rotation of the belt 41 following the rotation of the fixed pulley 47.

### (Upstream Support Frame 18, Downstream Support Frame 19)

As shown in FIGS. 3 and 4, the upstream support frame 18 supports the upstream dust collecting container 12, the upstream movable pulley 22, the upstream guide pulley 23, the upstream support roller 28, the movable pulley 32, and the movable guide pulley 33. The upstream support frame 18 is movable along the first direction X while supporting the upstream laser head 11, the upstream dust collecting container 12, the upstream movable pulley 22, the upstream guide pulley 23, the upstream support roller 28, the movable pulley 32, and the movable guide pulley 33. In FIG. 3 and FIGS. 8 and 9 below, the upstream support frame 18 is surrounded by a dotted line.

As shown in FIG. 3, the downstream support frame 19 supports the downstream dust collecting container 14, the downstream movable pulley 25, the downstream guide pulley 26, the downstream support roller 29, the movable pulley 42, and the movable guide pulley 43. The downstream support frame 19 is movable along the first direction X while supporting the downstream laser head 13, the downstream dust collecting container 14, the downstream movable pulley 25, the downstream guide pulley 26, the downstream support roller 29, the movable pulley 42, and the movable guide pulley 43. In FIG. 3 and FIGS. 8 and 9 below, the downstream support frame 19 is surrounded by a dotted line.

The upstream support frame 18 and the downstream support frame 19 have similar shapes and are arranged symmetrically as shown in FIG. 3.

As shown in FIGS. 3 and 4, the upstream support frame 18 includes a first frame portion 18a, a second frame portion 18b, and a third frame portion 18c. The first frame portion 18a rotatably supports the upstream movable pulley 22 and the movable pulley 32 in the first direction X at a predetermined interval. The first frame portion 18a also rotatably supports the upstream support roller 28. The second frame portion 18b extends obliquely downward from the first frame portion 18a. The second frame portion 18b extends diagonally toward downstream as it goes downward. The second frame portion 18b has a lower end where the upstream guide pulley 23 is rotatably supported. The third frame portion 18c extends toward the upstream from the first frame portion 18a. At the upstream end in the first direction X of the third frame portion 18c, the movable guide pulley 33 is rotatably supported.

The downstream support frame 19 includes a first frame portion 19a, a second frame portion 19b, and a third frame portion 19c. The first frame portion 19a rotatably supports the downstream movable pulley 25 and the movable pulley 42 in the first direction X at a predetermined interval. The first frame portion 19a also rotatably supports the downstream support roller 29. The second frame portion 19b extends obliquely downward from the first frame portion 19a. The second frame portion 19b extends diagonally toward upstream as it goes downward. The second frame portion 19b has a lower end where the downstream guide pulley 26 is rotatably supported. The third frame portion 19c extends toward downstream from the first frame portion 19a. At the downstream end in the first direction X of the third frame portion 19c, the movable guide pulley 43 is rotatably supported.

The laser blanking device 5 further includes a moving mechanism 51 configured to move the upstream support frame 18 and the downstream support frame 19 along the first direction X, as shown in FIG. 2. The configuration for moving the upstream support frame 18 in the first direction X is similar to the configuration for moving the downstream support frame 19 in the first direction X, and thereby the upstream support frame 18 will be used for description below.

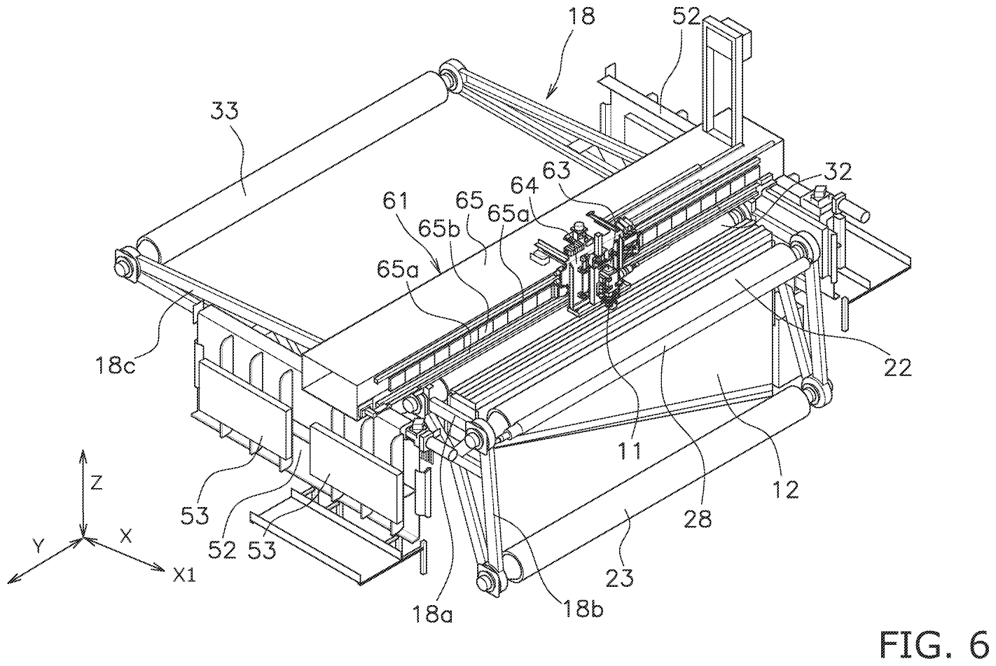

FIG. 6 shows a configuration in which the upstream dust collecting container 12, the upstream movable pulley 22, the upstream guide pulley 23, the upstream support roller 28, the movable pulley 32, and the movable guide pulley 33 are supported by the upstream support frame 18. FIG. 6 is also a diagram showing the upstream laser head 11 and a moving mechanism 61 which will be described later.

The moving mechanism 51 includes side carriages 52, coils 53, side frames 54, guide rails 55, and magnets 56, as shown in FIGS. 2 and 6.

The upstream support frame 18 is attached to a carriage support section 65, which will be described later, and the pair of side carriages 52 is attached to the carriage support section 65. The pair of side carriages 52 is arranged on both left and right sides of the upstream support frame 18 in the width direction (Y direction). Similarly, the pair of side carriages 52 is arranged on both left and right sides of the downstream support frame 19 in the Y direction, and the pair of side carriages 52 is connected to the carriage support section 65 to which the downstream support frame 19 is attached.

The side frames 54 are arranged on the left and right sides of the inter-head conveyor 15, the upstream conveyor 16, and the downstream conveyor 17 in the width direction. The pairs of side frames 54 are arranged so as to sandwich the inter-head conveyor 15, the upstream conveyor 16, and the downstream conveyor 17 therebetween. The guide rails 55 are arranged on the side frames 54. The guide rails 55 are arranged side by side in the up-down direction. Each of the guide rails 55 is arranged along the first direction X. As shown in FIG. 2, the side carriages 52 are disposed outside the side frames 54 in the width direction (Y direction). A plurality of sliders is disposed inside the side carriage 52 in the width direction, and the plurality of sliders is slidably fitted in the pair of upper and lower guide rails 55. As the sliders attached to the side carriage 52 slide along the guide rail 55, the upstream support frame 18 moves along the first direction X.

In the present embodiment, the sliders move relative to the guide rails 55 when driven by a linear motor as a driving source. A plurality of coils 53 are mounted to each of the side carriages 52 along the first direction X. A plurality of magnets 56 are disposed on the each of the side frames 54 along the guide rails 55. With controlling the flow of an electric current through the coils 53, the sliders move along the guide rails 55 in the first direction X.

### (Upstream Laser Head 11, Downstream Laser Head 13)

The upstream laser head 11 and the downstream laser head 13 are each configured to be movable in the first direction X, the second direction Y, and the third direction Z.

As shown in FIG. 2, the laser blanking device 5 further includes a moving mechanism 61 for moving the upstream laser head 11 in the second direction Y and the third direction Z, and a moving mechanism 62 for moving the downstream laser head 13 in the second direction Y and the third direction Z.

Note that the moving mechanism 61 and the moving mechanism 62 have similar configurations and that the upstream laser head 11 will be used for description.

As shown in FIG. 6, the moving mechanism 61 includes a first carriage 63, a second carriage 64, and a carriage support section 65.

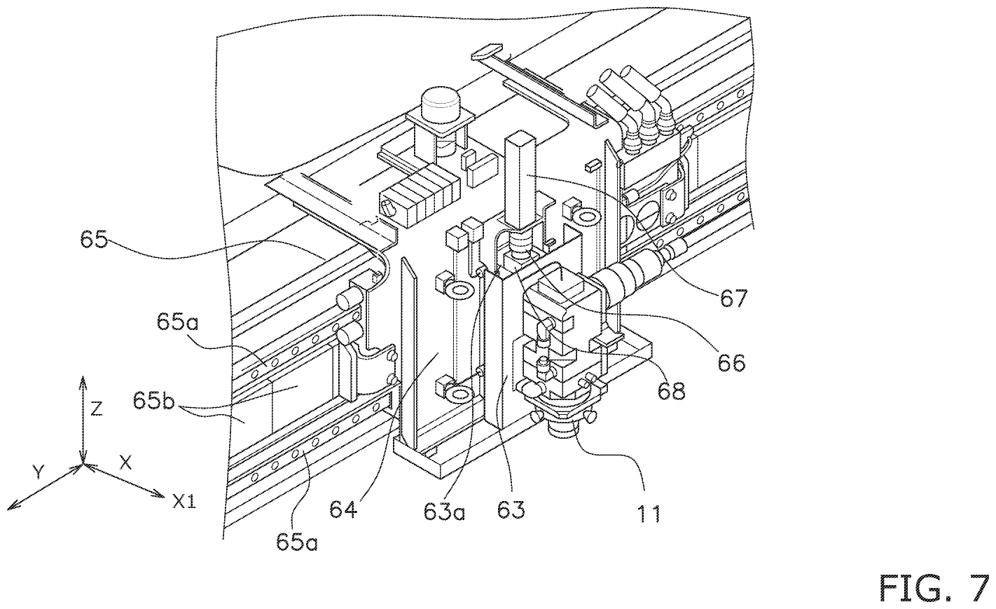

FIG. 7 is an enlarged view showing the upstream laser head 11 in FIG. 6 and therearound. As shown in FIG. 7, the upstream laser head 11 is disposed on the first carriage 63 configured to emit a laser downward. The upstream laser head 11 is arranged in a second carriage 64 via the first carriage 63. The first carriage 63 is in a substantially plate shape and has an upstream-side surface where a groove 63a is formed along the third direction Z. The groove 63a has a ball screw 66 inserted therein along the third direction Z. The ball screw 66 is rotatably supported by the second carriage 64. A drive motor 67 is placed on the upper side of the ball screw 66. A nut 68 is disposed inside the groove 63a, and the nut 68 is fixed to the first carriage 63. The nut 68 is threadedly engaged with the ball screw 66. When the ball screw 66 is rotated by the drive motor 67, the nut 68 moves in the third direction Z, and the first carriage 63 fixed to the nut 68 moves in the up-down direction. As a result, the upstream laser head 11 is moved in the third direction Z. Note that the mechanism for moving the upstream laser head 11 along the third direction Z is not limited to a ball screw, and may be a mechanism using a rack and pinion or a linear motor.

The carriage support section 65 is connected to the upstream support frame 18, as shown in FIG. 6. The carriage support section 65 is attached to the upper side of the upstream support frame 18. The carriage support section 65 is arranged along the second direction Y. The carriage support section 65 supports the second carriage 64 so that the second carriage 64 is movable along the second direction Y. As shown in FIG. 6, a pair of guide rails 65a is arranged on the downstream-side surface of the carriage support section 65 along the second direction Y. The sliders of the second carriage 64 are fitted in the pair of guide rails 65a. With this configuration, the second carriage 64 is slidable in the second direction Y along the guide rail 65a. The second carriage 64 is movable relative to the carriage support section 65 using a linear motor as a drive source. A plurality of magnets 65b is arranged side by side along the guide rails 65a. Coils (not shown) are disposed on the second carriage 64, and controlling the flow of an electricity through the coil allows the second carriage 64 to move along the second direction Y with respect to the carriage support 65.

Furthermore, the above-described movement of the upstream support frame 18 in the first direction X also allows the laser head 11 to move along the first direction X because the laser head 11 is supported by the carriage support section 65, which the upstream support frame 18 is attached to, via the first carriage 63 and the second carriage 64. Similarly, the downstream laser head 13 is also allowed to move along the first direction X.

As described above, the upstream laser head 11 is configured to be movable in the first direction X, the second direction Y, and the third direction Z, by the gantry structure. Similarly, the downstream laser head 13 is configured to be movable in the first direction X, the second direction Y, and the third direction Z, by the gantry structure.

### (Moving Range)

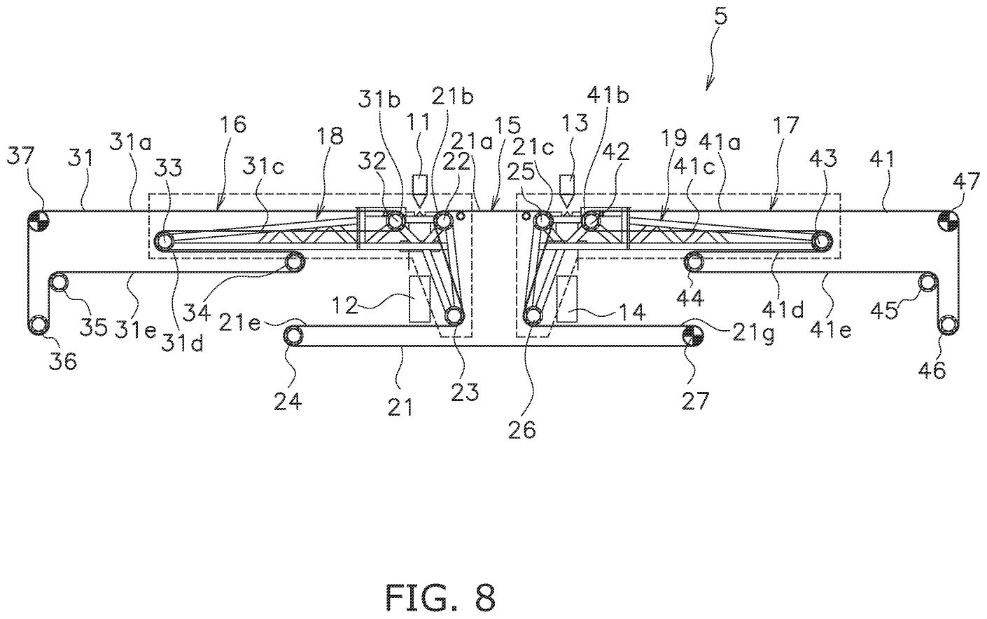

Next, the movement ranges of the upstream laser head 11 and the downstream laser head 13 will be explained. FIG. 3 is a diagram showing a state in which the upstream laser head 11 has moved to the upstreammost and the downstream laser head 13 has moved to the downstreammost. FIG. 8 is a diagram showing a state in which the upstream laser head 11 has moved downstream and the downstream laser head 13 has moved upstream from the state shown in FIG. 3. In FIG. 8, the length of the loading section 21a of the inter-head conveyor 15 in the conveyance direction X has become shorter, the length of the loading section 31a of the upstream conveyor 16 has become longer, and the length of the loading section 41a of the downstream conveyor 17 has become longer.

As shown in FIGS. 3 and 8, the upstream laser head 11 moves along the first direction X in a state where the loading section 21a of the belt 21 is kept parallel to the section 21e and the loading section 31a of the belt 31 is kept parallel to the sections 31c, 31d, and 31e. Further, the downstream laser head 13 moves along the first direction X in a state where the loading section 21a of the belt 21 is kept parallel to the section 21g and the loading section 41a of the belt 41 is kept parallel to the sections 41c, 41d, and 41e.

The upstream support frame 18 moves while supporting the upstream laser head 11, the upstream dust collecting container 12, the upstream movable pulley 22, the upstream guide pulley 23, the upstream support roller 28, the movable pulley 32, and the movable guide pulley 33. Accordingly, the upstream laser head 11, the upstream dust collecting container 12, the upstream movable pulley 22, the upstream guide pulley 23, the upstream support roller 28, the movable pulley 32, and the movable guide pulley 33 are able to move with their positional relationship being maintained. That is, the upstream movable pulley 22 and the movable pulley 32 are able to move while maintaining the distance therebetween configured for emission of a laser by the upstream laser head 11. Note that the downstream support frame 19 similarly moves while supporting the downstream laser head 13, the downstream dust collecting container 14, the downstream movable pulley 25, the downstream guide pulley 26, the downstream support roller 29, the movable pulley 42, and the movable guide pulley 43.

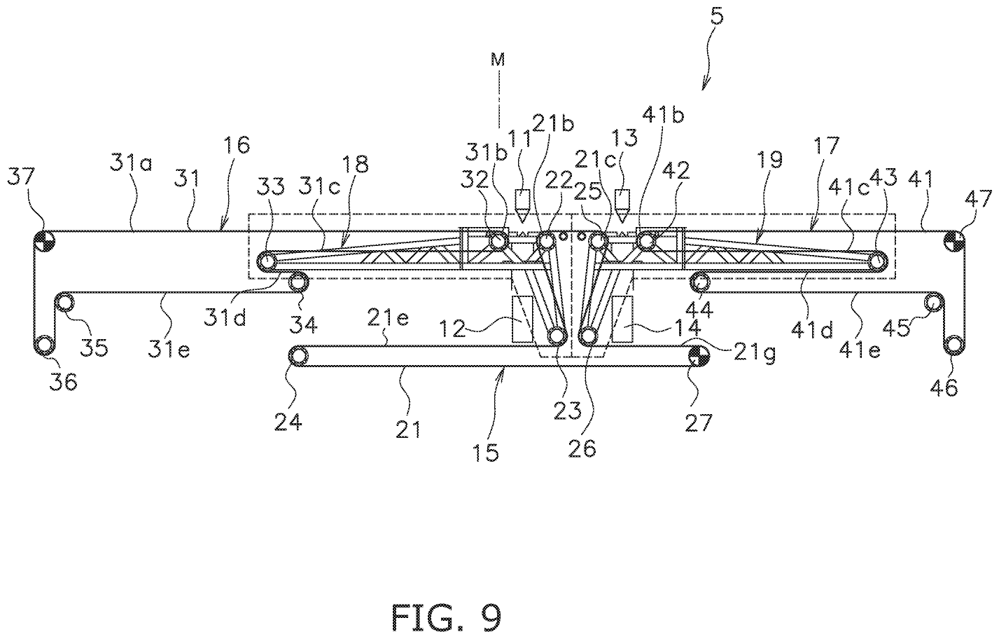

FIG. 9 is a diagram showing a state in which the upstream laser head 11 and the downstream laser head 13 are located closest to each other. In FIG. 9, the amount of movement of the upstream laser head 11 toward downstream is larger than the amount of movement of the downstream laser head 13 toward downstream from the state in the state in FIG. 3. FIG. 9 illustrates an intermediate position M. The intermediate position M is the middle point between the end 21b and the end 21c when the upstream end 21b of the loading section 21a has moved to the upstreammost and the downstream end 21c of the loading section 21a has moved to the downstreammost, as shown in FIG. 3. Note that the intermediate position M can be said to be the middle point between the upstream laser head 11 and the downstream laser head 13 when the upstream laser head 11 has moved to the upstreammost and the downstream laser head 13 has moved to the downstreammost. The upstream laser head 11 is movable downstream beyond the intermediate position M. The downstream laser head 13 is movable upstream beyond the intermediate position M.

FIG. 3 shows a position R1a where the upstream laser head 11 has moved to the upstreammost in the first direction X, a position Rib where the upstream laser head 11 has moved the downstreammost, and its movable range R1. FIG. 3 shows a position R2a where the downstream laser head 13 has moved to the upstreammost in the first direction X, a position R2b where the downstream laser head 13 has moved to the downstreammost, and its movable range R2. Also shown in FIG. 3 is the intermediate position M.

In the laser blanking device 5 of the present embodiment, as shown in FIG. 9, the upstream laser head 11 and the downstream laser head 13 are able to approach each other as long as the upstream guide pulley 23 and the downstream guide pulley 26 do not come into contact with each other.

As such, as shown in FIG. 3, the movable range R1 is able to overlap with the movable range R2 in the first direction X.

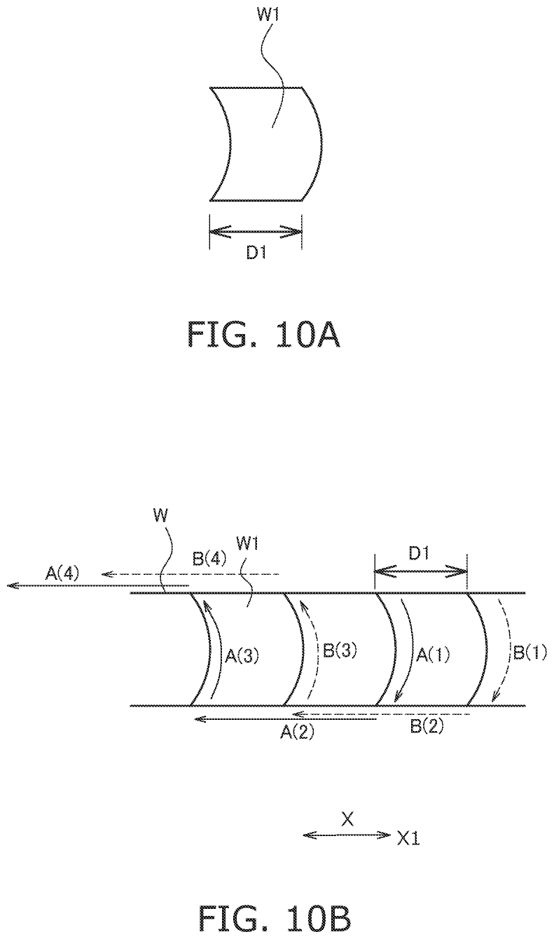

A case is here described in which a coil material is cut into a curved member W1 as shown in FIG. 10A. FIG. 10B is a diagram showing the movement of the upstream laser head 11 and the downstream laser head 13 with respect to the coil material. The movement of the upstream laser head 11 is indicated by solid arrows A (1), A (2), A (3), and A (4). The movement of the downstream laser head 13 is indicated by dotted arrows B (1), B (2), B (3), and B (4). The member W1 has a length D1 in the first direction X.

As shown by the arrow A (1), the upstream laser head 11, being directed downstream in the first direction X, cuts the coil material while moving from the left side to the right side with the left end as a starting point. The upstream laser head 11 then moves toward upstream in the first direction X, as shown by the arrow A (2). Furthermore, as shown by the arrow A (3), the upstream laser head 11 cuts the coil material while moving from the right side to the left side, and as shown by the arrow A (4), the upstream laser head 11 moves toward upstream in the first direction X. Similarly, as shown by the arrow B (1), the downstream laser head 13, being directed downstream in the first direction X, cuts the coil material while moving from the left side to the right side with the left end as a starting point. The downstream laser head 13 then moves toward upstream in the first direction X, as shown by the arrow B (2). Furthermore, as shown by the arrow B (3), the downstream laser head 13 cuts the coil material while moving from the right side to the left side, and as shown by the arrow B (4), the downstream laser head 13 moves toward upstream in the first direction X.

In FIG. 10B, the movement of each laser head with respect to the coil material in a stationary state is shown to make it easier to visualize the cut shape when the material is cut. However, in practice, the material cutting is performed by each laser head while conveying a coil material.

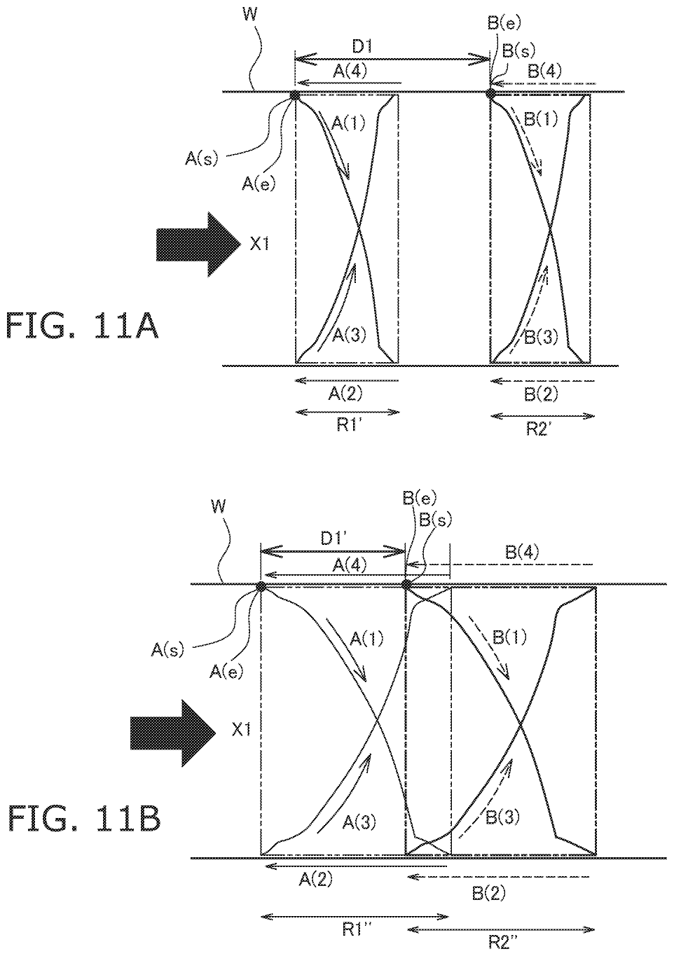

FIG. 11A is a diagram showing the movement of the upstream laser head 11 and the downstream laser head 13 in a case where a coil material is cut while the material is conveyed at a predetermined conveyance speed, and shows the movement of the upstream laser head 11 and the downstream laser head 13 relative to the laser blanking device 5 that is in a stationary state. In FIG. 11A, the same reference numerals as those for the movement in FIG. 10B are shown. The starting point of the upstream laser head 11 is indicated by A(s), and the ending point after moving along the arrow A (4) is indicated by A (e). The starting point A(s) and the ending point A (e) are set to match. The starting point of the downstream laser head 13 is indicated by B(s), and the ending point after moving along the arrow B (4) is indicated by B (e). The starting point B(s) and the ending point B (e) are set to match. In the state shown in FIG. 11 (a), the movement range R1′ of the upstream laser head 11 and the movement range R2′ of the downstream laser head 13, for cutting the member W1, do not overlap.

In a case where the length of a member to be cut from a coil material in the first direction X is short, as shown in FIG. 11B, the movement range R1″ of the upstream laser head 11 and the movement range R2″ of the downstream laser head 13 are necessarily likely to overlap.

As described above using FIG. 3, in the laser blanking device 5 of the present embodiment, the movable range R1 of the upstream laser head 11 and the movable range R2 of the downstream laser head 13 overlap in the first direction X. Accordingly, the laser blanking device 5 of the present embodiment is adaptable with the case where the movement ranges of two laser heads overlap as shown in FIG. 11B.

The laser blanking device 5 of this embodiment includes the upstream laser head 11 (an example of a first laser head), the downstream laser head 13 (an example of a second laser head), and the inter-head conveyor 15. The upstream laser head 11 is configured to emit a laser. The downstream laser head 13 is disposed downstream of the upstream laser head 11 in the conveyance direction X1 of a workpiece W, and is configured to emit a laser. The inter-head conveyor 15 includes the loading section 21a (an example of a first loading section) on which a workpiece W is loaded between the upstream laser head 11 and the downstream laser head 13, and is configured to convey the workpiece W loaded thereon. The upstream end 21b (an example of a first end) of the loading section 21a is movable along the conveyance direction X1 together with the upstream laser head 11. The downstream end 21c (an example of a second end) of the loading section 21a is movable along the conveyance direction X1 together with the downstream laser head 13.

As described above, the upstream end 21b of the loading section 21a is movable together with the upstream laser head 11 along the conveyance direction X1, and the downstream end 21c of the loading section 21a is movable along the conveyance direction X1 together with the downstream laser head 13. This configuration allows the upstream laser head 11 and the downstream laser head 13 to approach each other in accordance with the distance at which the ends 21b and 21c are able to approach each other, which improve the closeness.

In the laser blanking device 5 of the present embodiment, when the middle point between the end 21b and the end 21c is defined as the intermediate position M in a state where the end 21b of the loading section 21a has moved to the upstreammost and the end 21c has moved to the downstreammost, the upstream laser head 11 is movable downstream beyond the intermediate position M, or the downstream laser head 13 is movable upstream beyond the intermediate position M.

With the configuration, the closeness between the upstream laser head 11 and the downstream laser head 13 can be improved.

In the laser blanking device 5 of the present embodiment, in the conveyance direction, the position R1b at the downstream end of the movable range R1 of the upstream laser head 11 is located downstream of the position R2a at the upstream end of the movable range R2 of the downstream laser head 13.

With the configuration, the movable range R1 of the upstream laser head 11 and the movable range R2 of the downstream laser head in the conveyance direction X1 overlap, and thereby the closeness between the upstream laser head 11 and the downstream laser head 13 can be improved.

In the laser blanking device 5 of the present embodiment, the inter-head conveyor 15 includes the belt 21 (an example of a first belt), the upstream movable pulley 22 (an example of a first movable pulley), the downstream movable pulley 25 (an example of a second movable pulley), the upstream fixed pulley 24 (an example of a first fixed pulley), the downstream fixed pulley 27 (an example of a second fixed pulley), the upstream guide pulley 23 (an example of a first guide pulley), and the downstream guide pulley 26 (an example of a second guide pulley). The belt 21 has an endless shape and includes the loading section 21a. The end 21b of the loading section 21a of the belt 21 is wound around the upstream movable pulley 22. The upstream movable pulley 22 is disposed inside the belt 21, The upstream movable pulley 22 is movable along the conveyance direction X1 together with the upstream laser head 11. The end 21c of the loading section 21a of the belt 21 is wound around the downstream movable pulley 25. The downstream movable pulley 25 is disposed inside the belt 21. The downstream movable pulley 25 is movable along the conveyance direction X1 together with the downstream laser head 13. The upstream fixed pulley 24 is arranged below the upstream movable pulley 22, is mounted at a fixed position, and has the belt 21 wound around it. The downstream fixed pulley 27 is arranged below the downstream movable pulley 25, is mounted at a fixed position, and has the belt 21 wound around it. The upstream guide pulley 23 guides the belt 21 between the upstream movable pulley 22 and the upstream fixed pulley 24, and is movable along the conveyance direction X1 together with the upstream laser head 11 and the upstream movable pulley 22. The downstream guide pulley 26 guides the belt 21 between the downstream movable pulley 25 and the downstream fixed pulley 27, and is movable along the conveyance direction X1 together with the downstream laser head 13 and the downstream movable pulley 25.

With this configuration, the ends 21b and 21c of the inter-head conveyor 15 are able to move along the conveyance direction X1 without using a long cylinder or the like to adjust the length of the belt 21. Accordingly, it is possible to move the upstream laser head 11 and the downstream laser head 13 at high speed.

The laser blanking device 5 of the present embodiment further includes the upstream dust collecting container 12 (an example of a first dust collecting container) and the downstream dust collecting container 14 (an example of a second dust collecting container). The upstream dust collecting container 12 is disposed below the upstream laser head 11 and is movable along the conveyance direction X1 together with the upstream laser head 11. The downstream dust collecting container 14 is disposed below the downstream laser head 13 and is movable along the conveyance direction X1 together with the downstream laser head 13. The upstream dust collecting container 12 is disposed outside the belt 21 and between the upstream fixed pulley 24 and the upstream guide pulley 23 in the conveyance direction X1. The downstream dust collecting container 14 is disposed outside the belt 21 and between the downstream fixed pulley 27 and the downstream guide pulley 26 in the conveyance direction X1.

With the configuration, the upstream dust collecting container 12 and the downstream dust collecting container 14 are able to move along the conveyance direction X1. Further, the upstream dust collecting container 12 is arranged between the upstream fixed pulley 24 and the upstream guide pulley 23 in the conveyance direction X1, and the downstream dust collecting container 14 is arranged between the downstream fixed pulley 27 and the downstream guide pulley 26 in the conveyance direction X1, and thereby the laser blanking device 5 can be compact.

The laser blanking device 5 of the present embodiment further includes the upstream conveyor 16. The upstream conveyor 16 is arranged upstream of the inter-head conveyor 15, includes the loading section 31a (an example of a second loading section) on which a workpiece W is loaded, and is capable of conveying the workpiece W loaded on it. The upstream conveyor 16 includes the endless belt 31 (an example of a second belt), the movable pulley 32 (an example of a third movable pulley), the fixed pulley 34 (an example of the third fixed pulley), and the movable guide pulley 33 (an example of a third movable pulley). The downstream end 31b (an example of a third end) of the loading section 31a of the belt 31 is wound around the movable pulley 32. The movable pulley 32 is disposed inside the belt 31. The movable pulley 32 is movable along the conveyance direction X1 together with the upstream laser head 11. The belt 31 is wound around the fixed pulley 34 below the movable pulley 32. The fixed pulley 34 is disposed inside the belt 31, and the fixed pulley 34 is mounted at a fixed position. The movable guide pulley 33 guides the belt 21 between the movable pulley 32 and the fixed pulley 34, and is movable along the conveyance direction X1 together with the upstream laser head 11 and the movable pulley 32.

With the configuration, the upstream laser head 11 is able to move along the conveyance direction X1 while maintaining a predetermined distance between the upstream conveyor 16 and the inter-head conveyor 15 below the upstream laser head 11.

The laser blanking device 5 of the present embodiment further includes the downstream conveyor 17. The downstream conveyor 17 is disposed downstream of the inter-head conveyor 15, includes the loading section 41a (an example of a third loading section) on which a workpiece W is loaded, and is capable of conveying the workpiece W loaded thereon. The downstream conveyor 17 includes the endless belt 41 (an example of a third belt), the movable pulley 42 (an example of a fourth movable pulley), the fixed pulley 44 (an example of a fourth fixed pulley), and the movable guide pulley 43 (an example of a fourth guide pulley). The upstream end 41b (an example of a fourth end) of the loading section 41a of the belt 41 is wound around the movable pulley 42. The movable pulley 42 is disposed inside the belt 41. The movable pulley 42 is movable along the conveyance direction X1 together with the downstream laser head 13. The belt 41 is wound around the fixed pulley 44 below the movable pulley 42. The fixed pulley 44 is disposed inside the belt 41. The fixed pulley 44 is mounted to a fixed position. The movable guide pulley 43 guides the belt 41 between the movable pulley 42 and the fixed pulley 44 and is movable along the conveyance direction X1 together with the downstream laser head 13 and the movable pulley 42.

With the configuration, the downstream laser head is able to move along the conveyance direction X1 while maintaining a predetermined distance between the downstream conveyor 17 and the inter-head conveyor 15 below the downstream laser head 13.

The laser blanking device 5 of the present embodiment further includes the upstream support frame 18 (an example of a first support frame). The upstream support frame 18 supports the upstream laser head 11, the upstream movable pulley 22, the upstream guide pulley 23, the movable pulley 32, and the movable guide pulley 33, and is movable along the conveyance direction X1.

With the configuration, the upstream support frame 18 is able to move along the conveyance direction X1 while maintaining the positional relationship between the upstream laser head 11, the upstream movable pulley 22, the upstream guide pulley 23, the movable pulley 32, and the movable guide pulley 33.

The laser blanking device 5 of the present embodiment further includes the downstream support frame 19 (an example of a second support frame). The downstream support frame 19 supports the downstream laser head 13, the downstream movable pulley 25, the downstream guide pulley 26, the movable pulley 42, and the movable guide pulley 43, and is movable along the conveyance direction X1.

With the configuration, the downstream support frame 19 is able to move the downstream laser head 13, the downstream movable pulley 25, the downstream guide pulley 26, the movable pulley 42, and the movable guide pulley 43 along the conveyance direction X1 while maintaining the positional relationship between them.

The laser blanking device 5 of the present embodiment includes the upstream laser head 11 (an example of a laser head), the belt 21 (an example of a first belt), the upstream movable pulley 22 (an example of a first inner pulley), the upstream guide pulley 23 (an example of a first outer pulley), the belt 31 (an example of a second belt), the movable pulley 32 (an example of a second inner pulley), and the movable guide pulley 33 (an example of a second outer pulley). The belt 21 is disposed downstream of the upstream laser head 11, includes the loading section 21a (an example of a first loading section) on which a workpiece W is loaded, and conveys the workpiece W loaded thereon. The upstream movable pulley 22 is disposed inside the upstream end 21b of the loading section 21a of the belt 21. and the belt 21 is wound around the upstream movable pulley 22. The upstream guide pulley 23 is disposed outside the belt 21, and the belt 21 is wound around the upstream guide pulley 23. The belt 31 is disposed upstream of the upstream laser head 11, includes the loading section 31a (an example of a second loading section) on which a workpiece W is loaded, and conveys the workpiece W loaded thereon. The movable pulley 32 is disposed inside the downstream end 31b of the loading section 31a of the belt 31, and the belt 31 is wound around the movable pulley 32. The movable guide pulley 33 is disposed outside the belt 31, and the belt 31 is wound around the movable guide pulley 33. The upstream movable pulley 22 and the movable pulley 32 are movable along the conveyance direction X1 while maintaining a predetermined distance between them.

With the configuration, the upstream laser head 11 is able to move along the conveyance direction X1 while maintaining a predetermined distance between the inter-head conveyor 15 and the upstream conveyor 16 below the upstream laser head 11.

The laser blanking device 5 of the present embodiment further includes the upstream support frame 18 (an example of a support frame). The upstream support frame supports the upstream movable pulley 22, the upstream guide pulley 23, the movable pulley 32, and the movable guide pulley 33. The upstream support frame 18 is movable along the conveyance direction X1 while maintaining the positional relationship between the upstream movable pulley 22, the upstream guide pulley 23, the movable pulley 32, and the movable guide pulley 33.

With the configuration, when the downstream support frame 18 is moved, the upstream movable pulley 22, the upstream guide pulley 23, the movable pulley 32, and the movable guide pulley 33 are able to move along the conveyance direction X1 while maintaining the positional relationship between them.

The laser blanking device 5 of the present embodiment includes the upstream fixed pulley 24 (an example of a first fixed pulley) and the fixed pulley 34 (an example of a second fixed pulley). The upstream fixed pulley 24 is disposed inside the belt 21. The belt 21 is wound around the upstream fixed pulley 24 The upstream fixed pulley 24 is mounted to a fixed position. The fixed pulley 34 is disposed inside the belt 31. The belt 31 is wound around the fixed pulley 34. The fixed pulley 34 is mounted at a fixed position. The upstream fixed pulley 24 is arranged below the upstream movable pulley 22, and the upstream guide pulley 23 is arranged between the upstream fixed pulley 24 and the upstream movable pulley 22. The fixed pulley 34 is arranged below the movable pulley 32, and the movable guide pulley 33 is arranged between the fixed pulley 34 and the movable pulley 32. The portion 21e of the belt 21 between the upstream fixed pulley 24 and the upstream guide pulley 23 and the loading section 21a of the belt 21 are parallel to each other. The portion 31d of the belt 31 between the fixed pulley 34 and the movable guide pulley 33 and a loading section 31a of the belt 31 are parallel to each other.

With this configuration, the laser heads are able to move along the conveyance direction X1 while maintaining a distance between the first conveyor belt and the second conveyor belt, without using a long cylinder or the like to adjust the length of the belt.

### OTHER EMBODIMENTS

One embodiment of the present invention has been described above. The claimed invention, however, is not limited to the above embodiment, and various changes can be made without departing from the gist of the invention.

In the above embodiment, a laser blanking device including two laser heads has been illustrated, but it is not limited to this configuration, and the laser blanking device 5 may include three or more laser heads.

In the above embodiment, the belts 21, 31, and 41 are each a single belt, but two or more belts may be arranged side by side in the second direction Y.

In the above embodiment, the upstream conveyor 16, inter-head conveyor 15, and downstream conveyor 17 are rotated by the driving force of a motor, but the motor may be omitted in some cases. For example, a configuration is possible in which the upstream conveyor 16 and the inter-head conveyor 15 are not actively rotated by a motor, but are passively rotated as the feeder 4 conveys a coil material. Before the coil material is completely separated by laser processing, the coil material is transported by the feeder 4, and thereby there is no need to actively transport it using driving force, and the conveyor can be rotated passively.

In a case where the conveyor is passively rotated, a configuration is not necessary where a belt is wound around pulleys, but instead, a roller or the like for supporting a coil material from below can be used. In this case, a plurality of rollers may be arranged on support members that are formed along the first direction X, and the plurality of support members may be arranged side by side in the second direction Y.

In the laser blanking device 5 of the above embodiment, a conveyor belt is used as the conveyor, but the conveyor is not limited to a belt and may be a chain conveyor or the like.

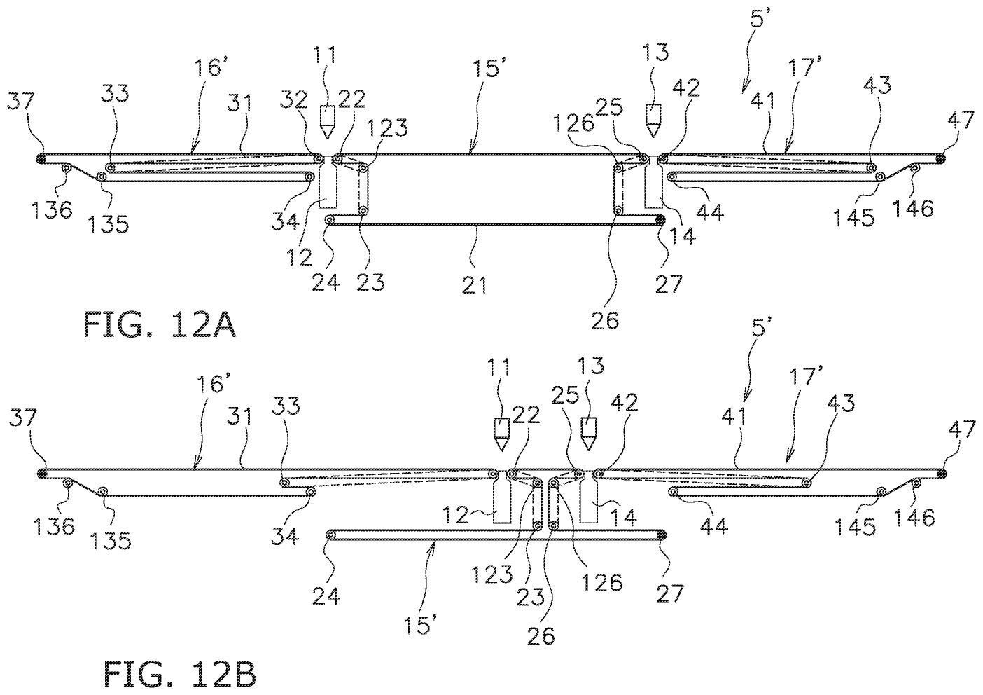

The configuration of the pulleys is not limited to that of the laser blanking device 5 of the above embodiment, and may be, for example, a configuration as shown in FIGS. 12A and 12B. The laser blanking device 5′ shown in FIG. 12A differs from the configuration of the laser blanking device 5 shown in FIG. 3 in the arrangement of pulleys. FIG. 12B is a diagram showing a state in which the upstream laser head 11 has moved to the downstream side, the downstream laser head 13 has moved to the upstream side, and the upstream laser head 11 and the downstream laser head 13 are located closest to each other.

Compared with the inter-head conveyor 15, the inter-head conveyor 15′ includes an upstream guide pulley 123 and a downstream guide pulley 126. The upstream guide pulley 123 is disposed outside the belt 21. The belt 21 is wound around the upstream guide pulley 123. The upstream guide pulley 123 is arranged between the upstream guide pulley 23 and the upstream movable pulley 22. The upstream guide pulley 123 is configured to move along the first direction X together with the upstream laser head 11. The downstream guide pulley 126 is disposed outside the belt 21. The belt 21 is wound around the downstream guide pulley 126. The downstream guide pulley 126 is arranged between the downstream guide pulley 26 and the downstream movable pulley 25. The downstream guide pulley 126 is configured to move along the first direction X together with the downstream laser head 13.

Compared to the upstream conveyor 16, the upstream conveyor 16′ is configured with a fixed guide pulley 135 and a fixed pulley 136 instead of the fixed guide pulley 35 and the fixed pulley 36. The fixed guide pulley 135 is different from the fixed guide pulley 35 and is disposed inside the endless belt 31. The fixed pulley 136 is different from the fixed pulley 36 and is disposed outside of the endless belt 31.

Furthermore, compared to the downstream conveyor 17, the downstream conveyor 17′ is configured with a fixed guide pulley 145 and a fixed pulley 146 instead of the fixed guide pulley 45 and the fixed pulley 46. The fixed guide pulley 145 is different from the fixed guide pulley 45 and is disposed inside the endless belt 41. The fixed pulley 146 is different from the fixed pulley 46 and is arranged outside of the endless belt 41.

The laser blanking device of the present disclosure has the effect of improving its productivity and is useful for laser blanking lines and the like.

1. A laser blanking device, comprising:
a first laser head configured to emit a laser;
a second laser head disposed downstream of the first laser head in a conveyance direction of a workpiece, the second laser head being configured to emit a laser beam; and
an inter-head conveyor including a first loading section disposed between the first laser head and the second laser head for loading the workpiece, the inter-head conveyor being configured to convey the workpiece loaded thereon,
a first end on an upstream side of the first loading section being movable along the conveyance direction together with the first laser head,
a second end on a downstream side of the first loading section being movable along the conveyance direction together with the second laser head.

2. The laser blanking device according to claim 1, wherein
when a middle point between the first end and the second end of the first loading section, in a state where the first end has moved to an upstreammost position and the second end has moved to a downstreammost position, is set as an intermediate position,
the first laser head is movable downstream beyond the intermediate position, and
the second laser head is movable upstream beyond the intermediate position.

3. The laser blanking device according to claim 1, wherein
in the conveyance direction, a downstream end of a movable range of the first laser head is positioned downstream of an upstream end of a movable range of the second laser head.

4. The laser blanking device according to claim 1, wherein
the inter-head conveyor includes
a first belt having an endless shape, the first belt including the first loading section;
a first movable pulley around which the first end of the first loading section of the first belt is wound, the first movable pulley being disposed inside the first belt, the first movable pulley being movable along the conveyance direction together with the first laser head:
a second movable pulley around which the second end of the first loading section of the first belt is wound, the second movable pulley being disposed inside the first belt, the second movable pulley being movable along the conveyance direction together with the second laser head;
a first fixed pulley disposed below the first movable pulley, the first fixed pulley being mounted to a fixed position, the first fixed pulley having the first belt wound therearound:
a second fixed pulley disposed below the second movable pulley, the second fixed pulley being mounted to a fixed position, the second fixed pulley having the first belt wound therearound;
a first guide pulley configured to guide the first belt between the first movable pulley and the first fixed pulley, the first guide pulley being movable along the conveyance direction together with the first laser head and the first movable pulley; and
a second guide pulley configured to guide the first belt between the second movable pulley and the second fixed pulley, the second guide pulley being movable along the conveyance direction together with the second laser head and the second movable pulley.

5. The laser blanking device according to claim 4, further comprising
a first dust collecting container disposed below the first laser head, the first dust collecting container being movable along the conveyance direction together with the first laser head; and
a second dust collecting container disposed below the second laser head, the second dust collecting container being movable along the conveyance direction together with the second laser head,
the first dust collecting container disposed outside the first belt having an endless shape and between the first fixed pulley and the first guide pulley in the conveyance direction,
the second dust collecting container disposed outside the first belt having an endless shape and between the second fixed pulley and the second guide pulley in the conveyance direction.

6. The laser blanking device according to claim 4, further comprising
an upstream conveyor disposed upstream of the inter-head conveyor, the upstream conveyor including a second loading section on which the workpiece is loaded, the upstream conveyor being configured to convey the workpiece loaded thereon,
the upstream conveyor including
a second belt having an endless shape;
a third movable pulley around which a third end on a downstream side of the second loading section of the second belt is wound, the third movable pulley being disposed inside the second belt, the third movable pulley being movable along the conveyance direction together with the first laser head;
a third fixed pulley around which the second belt is wound below the third movable pulley, the third fixed pulley being disposed inside the second belt, the third fixed pulley being mounted to a fixed position; and
a third guide pulley configured to guide the second belt between the third movable pulley and the third fixed pulley, the third guide pulley being movable along the conveyance direction together with the first laser head and the third movable pulley.

7. The laser blanking device according to claim 4, further comprising
a downstream conveyor disposed downstream of the inter-head conveyor, the downstream conveyor including a third loading section on which the workpiece is loaded, the downstream conveyor being configured to convey the workpiece loaded thereon,
the downstream conveyor including
a third belt having an endless shape;
a fourth movable pulley around which a fourth end on an upstream side of the third loading section of the third belt is wound, the fourth movable pulley being disposed inside the third belt, the fourth movable pulley being movable along the conveyance direction together with the second laser head;
a fourth fixed pulley around which the third belt is wound below the fourth movable pulley, the fourth fixed pulley being disposed inside the third belt, the fourth fixed pulley being mounted to a fixed position; and
a fourth guide pulley configured to guide the third belt between the fourth movable pulley and the fourth fixed pulley, the fourth guide pulley being movable along the conveyance direction together with the second laser head and the fourth movable pulley.

8. The laser blanking device according to claim 6, further comprising
a first support frame supporting the first laser head, the first movable pulley, the first guide pulley, the third movable pulley, and the third guide pulley, the first support frame being movable along the conveyance direction.

9. The laser blanking device according to claim 7, further comprising
a second support frame supporting the second laser head, the second movable pulley, the second guide pulley, the fourth movable pulley, and the fourth guide pulley, the second support frame being movable along the conveyance direction.

10. A laser blanking device, comprising:
a laser head configured to emit a laser;
a first belt having an endless shape, the first belt being disposed downstream of the laser head, the first belt including a first loading section on which a workpiece is loaded, the first belt being configured to convey the workpiece loaded thereon;
a first inner pulley disposed inside an end on an upstream side of the first loading section of the first belt, the first inner pulley having the first belt wound therearound;
a first outer pulley disposed outside the first belt, the first outer pulley having the first belt wound therearound;
a second belt disposed upstream of the laser head, the second belt including a second loading section on which the workpiece is loaded, the second belt being configured to convey the workpiece loaded thereon;
a second inner pulley disposed inside an end on a downstream side of the second loading section of the second belt, the second inner pulley having the second belt wound therearound; and
a second outer pulley disposed outside the second belt, the second outer pulley having the second belt wound therearound,
the first inner pulley and the second inner pulley being movable along a conveyance direction while maintaining a predetermined distance between the first inner pulley and the second inner pulley.

11. The laser blanking device according to claim 10, further comprising
a support frame configured to support the first inner pulley, the first outer pulley, the second inner pulley, and the second outer pulley,
the support frame being movable along the conveyance direction while maintaining a positional relationship between the first inner pulley, the first outer pulley, the second inner pulley, and the second outer pulley.

12. The laser blanking device according to claim 10, further comprising
a first fixed pulley disposed inside the first belt, the first fixed pulley being mounted to a fixed position, the first fixed pulley having the first belt wound therearound; and
a second fixed pulley disposed inside the second belt, the second fixed pulley being mounted to a fixed position, the second fixed pulley having the second belt wound therearound,
the first fixed pulley being disposed below the first inner pulley, the first outer pulley being disposed between the first fixed pulley and the first inner pulley,
the second fixed pulley being disposed below the second inner pulley, the second outer pulley being disposed between the second fixed pulley and the second inner pulley,
a portion of the first belt between the first fixed pulley and the first outer pulley being parallel to the first loading section of the first belt, and
a portion of the second belt between the second fixed pulley and the second outer pulley being parallel to the second loading section of the second belt.

13. The laser blanking device according to claim 6, further comprising
a downstream conveyor disposed downstream of the inter-head conveyor, the downstream conveyor including a third loading section on which the workpiece is loaded, the downstream conveyor being configured to convey the workpiece loaded thereon,
the downstream conveyor including
a third belt having an endless shape;
a fourth movable pulley around which a fourth end on an upstream side of the third loading section of the third belt is wound, the fourth movable pulley being disposed inside the third belt, the fourth movable pulley being movable along the conveyance direction together with the second laser head;
a fourth fixed pulley around which the third belt is wound below the fourth movable pulley, the fourth fixed pulley being disposed inside the third belt, the fourth fixed pulley being mounted to a fixed position; and
a fourth guide pulley configured to guide the third belt between the fourth movable pulley and the fourth fixed pulley, the fourth guide pulley being movable along the conveyance direction together with the second laser head and the fourth movable pulley.

14. The laser blanking device according to claim 13, further comprising a second support frame supporting the second laser head, the second movable pulley, the second guide pulley, the fourth movable pulley, and the fourth guide pulley, the second support frame being movable along the conveyance direction.
